(19) United States
(12) Patent Application Publication
(10) Pub. No.: US 2021/0001876 A1
(43) Pub. Date: Jan. 7, 2021

(54) DRIVING ASSISTANCE APPARATUS

(71) Applicant: DENSO CORPORATION, Kariya-city (JP)

(72) Inventor: Taiichiro ICHIMARU, Kariya-city (JP)

(21) Appl. No.: 17/026,112

(22) Filed: Sep. 18, 2020

Related U.S. Application Data
(63) Continuation of application No. PCT/JP2019/007052, filed on Feb. 25, 2019.

(30) Foreign Application Priority Data
Mar. 23, 2018 (JP) 2018-056249

(51) Int. Cl. B60W 50/16; B60W 10/11

(52) U.S. Cl. CPC B60W 50/16; B60W 2540/16; B60W 2510/10; B60W 10/11

(57) ABSTRACT

A driving assistance apparatus includes: a detector that detects a shift position of a transmission of a vehicle; a stimulator that stimulates a driver; a stimulation controller that controls actuation of the stimulator to stimulate the driver in a stimulation pattern in accordance with the shift position; and a determiner that determines whether to be necessary to stimulate the driver even when the shift position is changed.

### CROSS REFERENCE TO RELATED APPLICATIONS

The present application is a continuation application of International Patent Application No. PCT/JP2019/007052 filed on Feb. 25, 2019, which designated the U.S. and claims the benefit of priority from Japanese Patent Application No. 2018-056249 filed on Mar. 23, 2018. The entire disclosures of all of the above applications are incorporated herein by reference.

### TECHNICAL FIELD

The present disclosure relates to a driving assistance apparatus.

### BACKGROUND

A configuration of preventing an erroneous starting of a vehicle has been known. In this configuration, an initial state of an automobile that can start or accelerate in accordance to depression of an accelerator is identified. A start direction of the automobile and an obstacle existing in the start direction are identified. When a behavior as a sign of an erroneous starting is detected in the initial state, a precaution operation such as a sudden stop is performed.

### SUMMARY

A driving assistance apparatus may include: a detector that may detect a shift position of a transmission of a vehicle; a stimulator that may stimulate a driver; a stimulation controller that may control actuation of the stimulator to stimulate the driver in a stimulation pattern in accordance with the shift position; and a determiner that may determine whether to be necessary to stimulate the driver even when the shift position is changed.

### BRIEF DESCRIPTION OF DRAWINGS

The above and other features and advantages of the present disclosure will become more apparent from the following detailed description made with reference to the accompanying drawings. In the drawings:

FIG. 1 is a block diagram showing a driving assistance apparatus according to a first embodiment;

FIG. 2 is a top view of a seat surface of a seat;

FIG. 3 is a partial cross-sectional view of a vibration applying device;

FIG. 4 is a diagram showing a vibration pattern 1;

FIG. 5 is a diagram showing a vibration pattern 2;

FIG. 6 is a diagram showing a vibration pattern 3;

FIG. 7 is a diagram showing a vibration pattern 4;

FIG. 8 is a diagram showing a data configuration that associates shift positions with the vibration patterns;

FIG. 9 is a flowchart showing a seat vibration control; and

FIG. 10 is a flowchart of the seat vibration control according to a second embodiment.

### DETAILED DESCRIPTION

In a case of a configuration that, after a driver depresses the accelerator, the precaution operation such as the sudden stop is performed, there is a difficulty that the driver may be mentally burdened. In order to solve this difficulty, it may be desired to be capable of notifying the driver that the driver performs the erroneous operation at a stage of a shift operation.

Further, in another configuration, a shift position is displayed on a display portion such as a meter panel. According to this configuration, by looking at the display position described above, the driver can relatively safely confirm the shift position without greatly moving a line of sight. However, in a case where the driver performs the erroneous operation of a shift lever, when the driver does not look at the display of the shift position, the driver cannot notice the erroneous operation. It has been known that an alarm sound is generated when the shift position is shifted to the reverse “R”. However, the driver may not hear the alarm sound described above in some vehicle interior environments.

One example of the present disclosure provides a driving assistance apparatus capable of surely notifying a driver of an erroneous operation at a stage of a shift operation and preventing the driver from being mentally burdened.

According to one example embodiment, a driving assistance apparatus includes: a detector that detects a shift position of a transmission of a vehicle; a stimulator that stimulates a driver; a stimulation controller that controls actuation of the stimulator to stimulate the driver in a stimulation pattern in accordance with the shift position; and a determiner that determines whether to be necessary to stimulate the driver even when the shift position is changed. Even in a case where the shift position is changed, the stimulation controller controls the stimulator not to stimulate the driver when the determiner determines to be unnecessary to stimulate the driver. The determiner determines to be unnecessary to stimulate the driver when a setting time does not elapse after the detector detects that the shift position is changed. Even in a case where the setting time elapses after the determiner detects that the shift position is changed, the determiner determines to be unnecessary to stimulate the driver when the vehicle travels on a road.

### First Embodiment

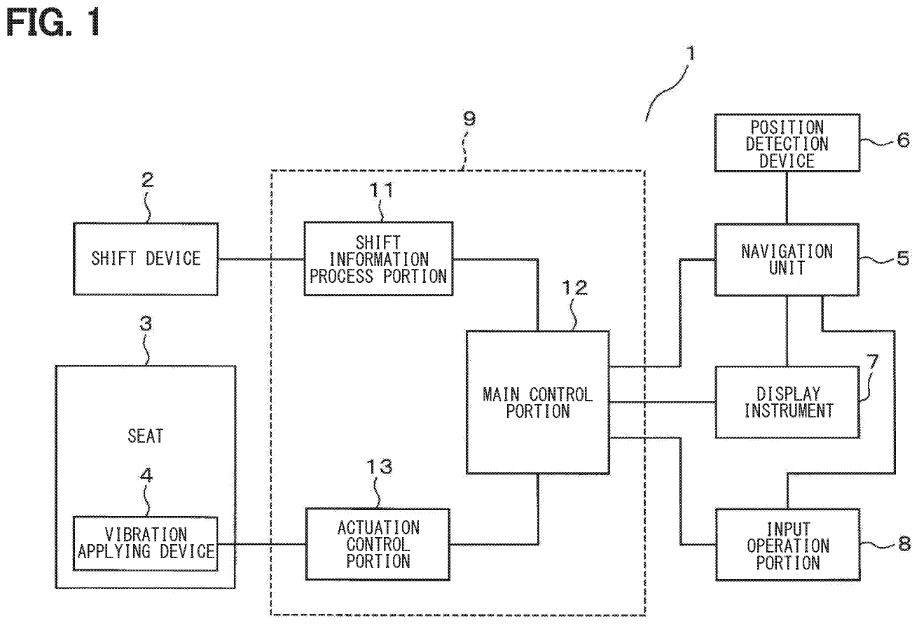

Hereinafter, a first embodiment of the present disclosure will be described with reference to FIGS. 1 to 9. A driving assistance apparatus 1 of the present embodiment is used in a state where the driving assistance apparatus is mounted on a vehicle. As shown in FIG. 1, the driving assistance apparatus 1 includes a shift device 2, a vibration applying device 4 placed in a seat 3 of a driver, a navigation unit 5, a position detection device 6, a display instrument 7, an input operation portion 8, and an in-vehicle control device 9.

The shift device 2 detects an operation position of a shift lever of a transmission deice of the vehicle, that is, a shift position, and transmits a shift position detection signal to the in-vehicle control device 9 via an in-vehicle LAN such as CAN. The vibration applying device 4 is built in, for example, a seat cushion of the seat 3 of the driver. Vibration output from the vibration applying device 4 is applied to hips or legs of the driver and the driver sitting on the seat 3 receives a tactile stimulation. The vibration applying device 4 has a function as a stimulator. A detailed configuration of the vibration applying device 4 will be described later.

The navigation unit 5 has a function of inputting a detection signal of a current position of the vehicle detected by the position detection device 6 and calculating a guide route from the current position to a destination, a function of performing a route guidance along the calculated guidance route, or the like. The navigation unit 5 transmits information of the current position of the vehicle to the in-vehicle control device 9. The navigation unit 5 displays map information, guide route information, route guidance information, or the like on the display instrument 7. The navigation unit 5 inputs information of the destination or various operation information via the input operation portion 8. The position detection device 6 includes, for example, a GPS receiver or the like, and has a function of measuring the current position of the vehicle. The position detection device 6 has a function as a detector.

The display instrument 7 includes, for example, a liquid crystal display or the like, and is placed at, for example, a center of an instrument panel. The display instrument 7 displays display information transmitted from the navigation unit 5 or the in-vehicle control device 9. The input operation portion 8 includes, a touch panel placed on a screen of the display instrument 7, a mechanical switch placed on the periphery of the display instrument 7, a remote controller, or the like. When a user performs input operation, the input operation portion 8 transmits input operation signal to the navigation unit 5 and the in-vehicle control device 9.

The in-vehicle control device 9 has a function of controlling the entire of the driving assistance apparatus 1, and includes a shift information process portion 11, a main control portion 12, and an actuation control portion 13. The in-vehicle control device 9 has a function as a stimulation controller. The shift information process portion 11 inputs the detection signal of the shift position detected by the shift device 2, that is, information, detects a shift position change, and transmits the shift position information to the main control portion 12 when the change is detected.

The main control portion 12 determines a vibration pattern generated by the vibration applying device 4 based on the shift position information from the shift information process portion 11 and the current position information of the vehicle from the navigation unit 5, and transmits the vibration control signal indicating the determined vibration pattern to the actuation control portion 13. A detailed content of a control in which the main control portion 12 determines the vibration pattern will be described later.

The actuation control portion 13 receives the vibration control signal from the main control portion 12, controls actuation of the vibration applying device 4 based on the corresponding vibration control signal and vibration pattern information stored inside the actuation control portion 13. A detailed content of the vibration pattern information will be described later.

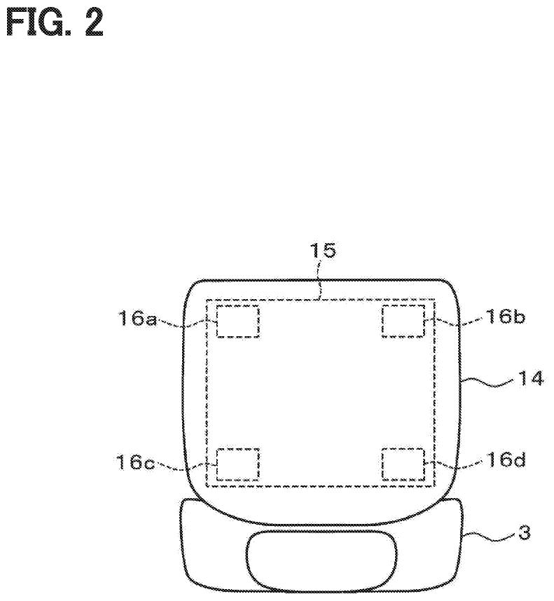

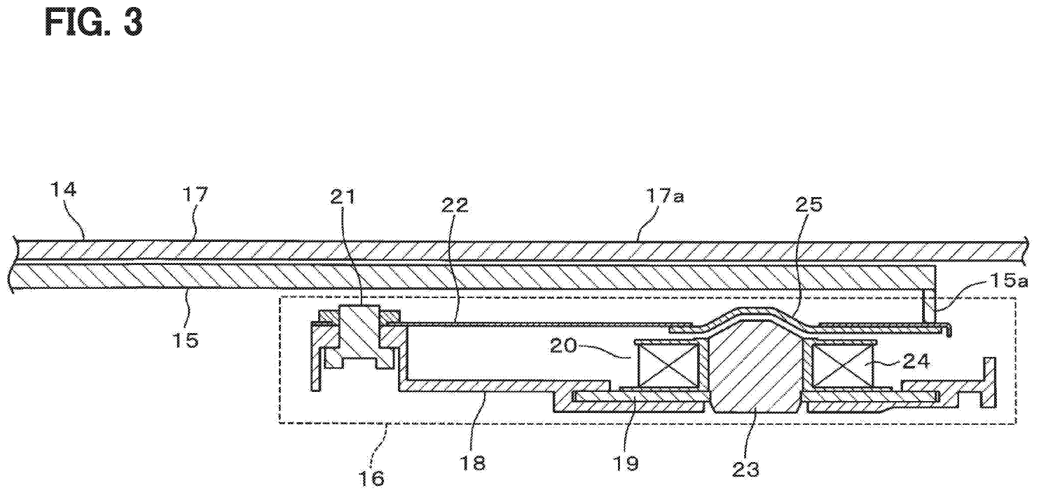

Here, the detailed configuration of the vibration applying device 4 will be described with reference to FIG. 2 and FIG. 3. As show in FIG. 2, the vibration applying device 4 includes a vibration plate 15 placed inside a seat cushion 14 of the seat 3 and four vibration actuators 16 respectively arranged at four corners of a lower surface of the vibration plate 15.

The vibration plate 15 has a rectangular shape. The size of the vibration plate 15 is substantially same as or slightly smaller than the size of a seat surface portion of the seat cushion 14. As shown in FIG. 3, an outer shell 17 of the seat cushion 14 is configured by bonding an outer skin and a cushion member. The vibration plate 15 is placed along an inner surface of a portion 17a, that is, a lower surface, corresponding to a seat surface portion of this outer shell 17.

The vibration actuator 16 includes a frame 18, an electromagnet 20 attached to a right end, in FIG. 3, that is one end of the frame 18 via a substrate 19, and a plate spring 22 attached to a left end that is another end of the frame 18 via a holder 21. The electromagnet 20 has a fixed yoke 23 fixed to the substrate 19 and a winding 24 wound around this fixed yoke 23.

A movable yoke 25 is attached to a tip end of the plate spring 22 by, for example, caulking so as to face an upper end of the fixed yoke 23 of the electromagnet 20 with a predetermined gap. A protrusion 15a protruding from an end of the vibration plate 15 contacts to a tip end of the plate spring 22.

In this configuration, when a current is supplied to the winding 24 of the electromagnet 20 and thereby the electromagnetic force is generated, the movable yoke 25 is attracted to the side of the fixed yoke 23 due to this electromagnetic force, and the plate spring 22 is deformed. When the plate spring 22 is vibrated, by supplying an actuation current, for example, a PWM signal to the winding 24 from the actuation control portion 13, the electromagnetic force is generated. When the movable yoke 25 is actuated, that is, attracted and thereafter the actuation is stopped, the vibration plate 15 linked to the plate spring 22 and the plate spring 22 are vibrated due to the spring reaction force. This vibration of the vibration plate 15 is applied to the driver via the seat surface of the seat cushion 14, and thereby the tactile stimulation is applied to the driver.

In the present embodiment, the vibration actuators 16 of the configuration described above are respectively arranged at the four corners of the lower surface of the vibration plate 15. In the present embodiment, the number of vibration actuators 16 is four. However, it is not limited to this. The number of vibration actuators 16 may be equal to or more than 5, or equal to or less than 3.

Here, the vibration pattern for vibrating the seat cushion 14 of the seat 3 by the vibration applying device 4 will be described. In the present embodiment, various vibration patterns are generated by adjusting a timing and intensity of the vibration of the four vibration actuators 16 of the vibration applying device 4.

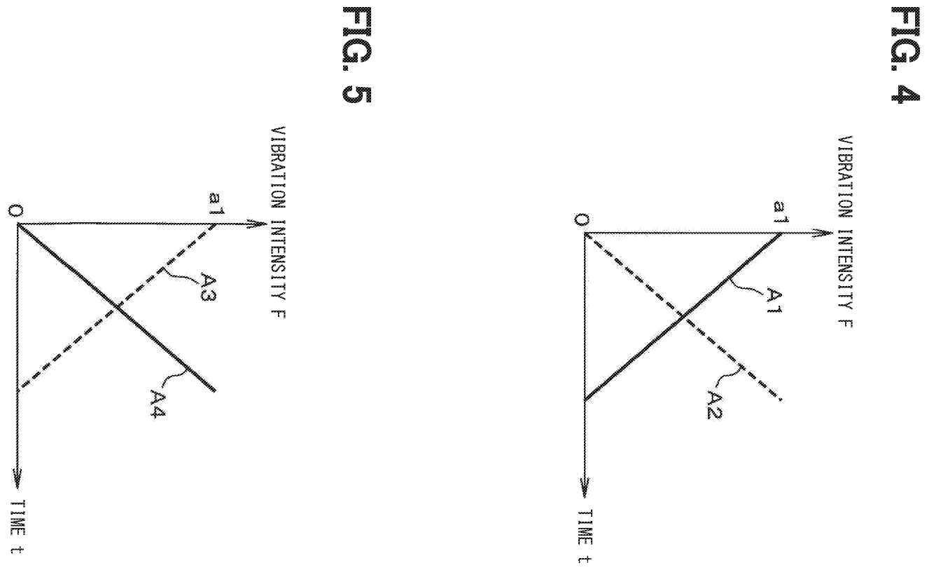

For example, when the shift position is shifted to R (that is, reverse), the seat 3 is vibrated in a vibration pattern 1. In the vibration pattern 1, the vibration flows from the front to the rear. The vibration is applied to the driver. In a case of this vibration pattern 1, while the vibration intensity of two front vibration actuators 16a and 16b is gradually decreased to be 0 from a setting value a1 as shown by a straight line A1 in FIG. 4, the vibration intensity of two rear vibration actuators 16c and 16d is gradually increased to be the setting value a1 from 0 as shown in a broken line A2 in FIG. 4. Thereby, the vibration pattern 1 is implemented.

When the shift position is shifted to D (that is, drive), the vibration in a vibration pattern 2 is applied to the driver. In the vibration pattern 2, the vibration that flows from the rear to the front. In a case of this vibration pattern 2, while the vibration intensity of the two rear vibration actuators 16c and 16d is gradually decreased to be 0 from the setting value a1 as shown by a broken line A3 in FIG. 5, the vibration intensity of the two front vibration actuators 16a and 16b is gradually increased to be the setting value a1 from 0 as shown in a straight line A4 in FIG. 5. Thereby, the vibration pattern 2 is implemented.

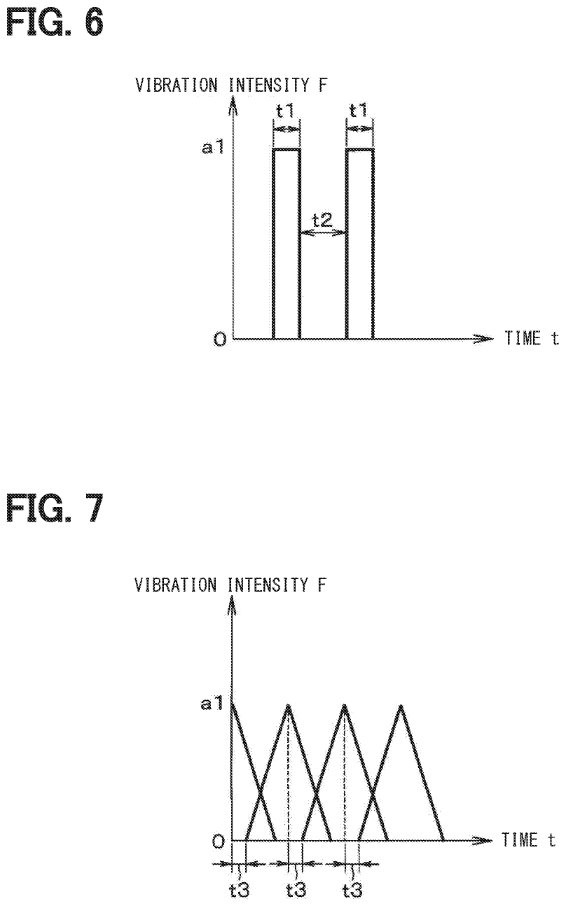

When the shift position is changed to N (that is, neutral), the vibration is applied to the driver in a vibration pattern 3 in which a single vibration that simultaneously vibrates all the vibration actuators 16a, 16b, 16c, and 16d is performed twice. In a case of this vibration pattern 3, as shown in FIG. 6, the vibration intensity is set to the setting value a1 and the four vibration actuators 16a, 16b, 16c, and 16d are actuated fora setting time t1, which is performed twice with a setting time interval t2. Thereby, the vibration pattern 3 is implemented.

When the shift position is changed to L (that is, low), the vibration actuator 16a, the vibration actuator 16b, the vibration actuator 16c, and the vibration actuator 16d are sequentially vibrated and thereby the vibration is applied to the driver in a vibration pattern 4 such that a circle is drawn. In a case of this vibration pattern 4, as shown in FIG. 7, the vibration intensity of the vibration actuator 16a is gradually decreased from the setting value a1 to 0. The vibration by the vibration actuator 16b is delayed by only a setting time t3 from the vibration start of the vibration actuator 16a and the vibration intensity of the vibration actuator 16b is gradually increased from 0 to the setting value a1. The vibration intensity of the vibration actuator 16b is gradually decreased from the setting value a1 to 0. The vibration by the vibration actuator 16c is delayed by only the setting time t3 from the time when the vibration intensity of the vibration actuator 16b reaches the setting value a1, and the vibration intensity of the vibration actuator 16c is gradually increased from 0 to the setting value a1. Thereafter, the vibration intensity of the vibration actuator 16c is gradually decreased from the setting value a1 to 0. The vibration by the vibration actuator 16d is delayed by only the setting time t3 from a time when the vibration intensity of the vibration actuator 16c reaches the setting value a1, and the vibration intensity of the vibration actuator 16d is gradually increased from 0 to the setting value a1. Further, the vibration intensity of the vibration actuator 16d is gradually decreased from the setting value a1 to 0. Thereby, the vibration pattern 4 is implemented. In this way, the vibration patterns 1, 2, 3, and 4 corresponding to the shift positions R, D, N, and L are implemented.

Next, in the present embodiment, the above-described four types of vibration patterns 1, 2, 3, and 4 can be adjusted, that is, tuned. It is conceivable that the preference of the vibration pattern, the preference of the vibration intensity in each vibration pattern, an actuation time of the vibration, the number of vibration execution times, or the like may be different depending on the individual driver. Therefore, in the present embodiment, the correspondence relation between the shift positions R, D, N, and L and the vibration patterns 1, 2, 3, and 4 can be changed, and the vibration intensity in each of the vibration patterns 1, 2, 3, and 4, the actuation time of the vibration, and the number of vibration execution times, or the like can be changed.

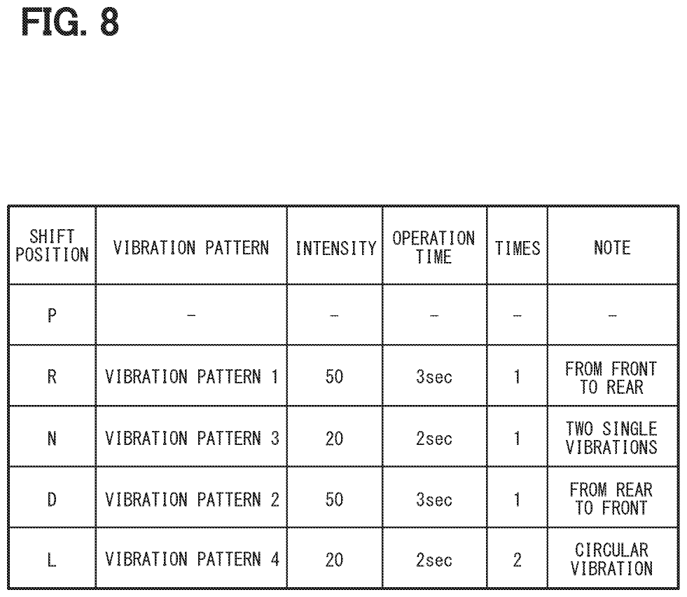

Specifically, an adjustment result is managed by a matrix data structure having a configuration as shown in FIG. 8. In the matrix data structure shown in FIG. 8, the vibration patterns 1, 2, 3, and 4 can be switched. The numerical value of the vibration intensity can be changed. The numerical value (for example, seconds) of the operation time for each operation can be changed. The numerical value of the number of execution times can be changed. The matrix data structure in which the numerical values or the like is changed is stored in the memory in the main control portion 12 of the in-vehicle control device 9.

For example, in the present embodiment, when a work menu for adjusting the vibration pattern or the like is selected, the matrix data structure shown in FIG. 8 is displayed in the display instrument 7. The input operation portion 8 is operated, and thereby a vibration pattern name of each column of the matrix data structure described above, the numerical value, or the like can be changed. When the changed matrix data structure, that is, the updated matrix data structure is stored in the memory in the main control portion 12. As a result, it may be possible to adjust the vibration pattern to the driver's preference.

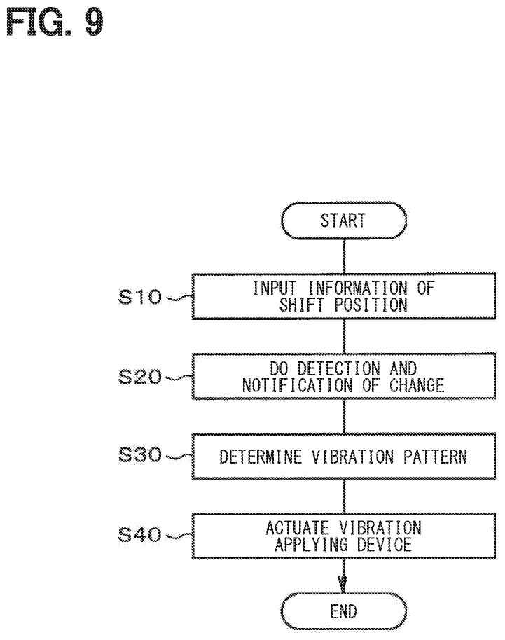

Next, the operation of the configuration described above, that is, the seat vibration control of the in-vehicle control device 9 will be described with reference to a flowchart of FIG. 9. In S10 of FIG. 9, when the driver operates the shift lever of a transmission device, the shift information process portion 11 of the in-vehicle control device 9 inputs the detection signal of the shift position, that is, information from the shift device 2. Next, the process shifts to S20. When the shift information process portion 11 detects change of the shift position based on the information of the shift position described above, and transmits information of the shift position after the change is detected to the main control portion 12, that is, notifies the main control portion 12 of the information.

The process shifts to S30. The main control portion 12 receives the shift position information from the shift information process portion 11, determines which vibration pattern to vibrate the seat 3 based on the received shift position information and the matrix data structure shown in FIG. 8, and transmits the vibration control information of the determined vibration pattern to the actuation control portion 13.

Next, the process shifts to S40. The actuation control portion 13 performs the actuation control on the vibration actuators 16a to 16d of the vibration applying device 4 based on the received vibration control information of the vibration pattern, and thereby vibrates the seat 3 in the vibration pattern described above. Thereby, the driver can recognize the shift position based on the vibration pattern of the seat 3.

Accordingly, the driver can clearly recognize the erroneous operation when the shift position intended to be changed by the shift operation and the shift position recognized by the vibration pattern described above do not match. That is, it may be possible to prevent the driver from being mentally burdened since the driver can be surely notified of the erroneous operation at the stage of the shift operation.

### Second Embodiment

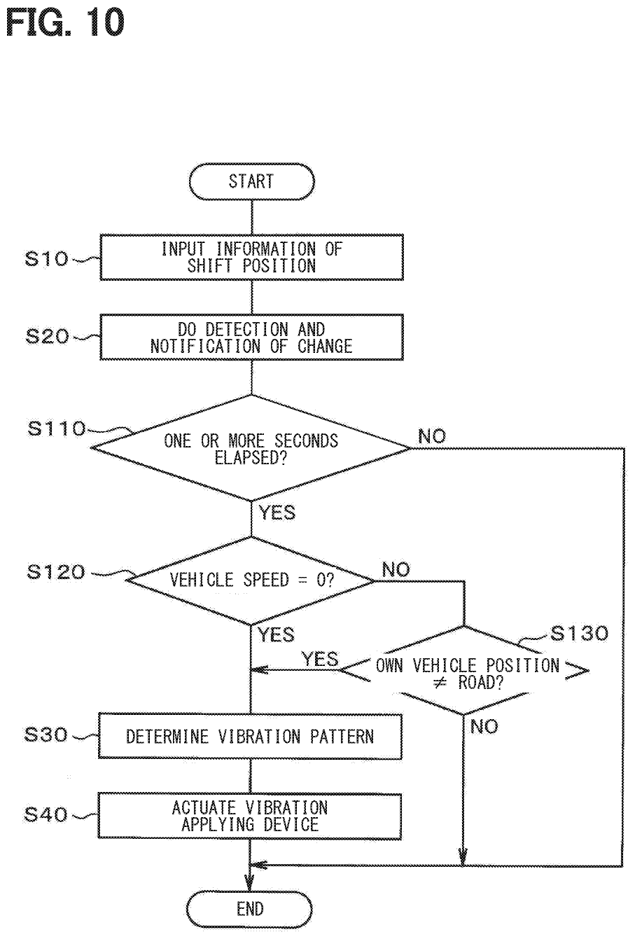

FIG. 10 shows a second embodiment. A configuration identical to that according to the first embodiment is denoted by an identical reference sign. In the case of the first embodiment described above, the seat 3 is vibrated each time when the shift lever is changed and operated. Therefore, the driver may feel annoyed. For example, when the vehicle travels down a slope, the shift operation may be performed so that the shift position is alternately changed between D and L. However, the vibration of the seat 3 occurs each time when the shift position is switched. In the case of such a shift operation, it may be considered sufficient to display only the shift position on the meter since a risk of an accident due to an incorrect shift input is low.

As a general shift operation, when the shift position is changed from P to D, it is necessary to move the shift lever in order of P, R, N, and D. However, it is detected that shift position is changed to R, N, and D for a moment, and thereby the seat 3 is vibrated. Therefore, the driver may feel annoyed.

Accordingly, in the second embodiment, even in a case where the shift position is changed, when the driver may feel annoyed, the seat 3 is not vibrated. A specific control of the second embodiment will be described with reference to a flowchart shown in FIG. 10.

The processes in S10 and S20 are executed similarly to the first embodiment. The process shifts to S110. After detecting that the shift position is change, the main control portion 12 determines whether a predetermined setting time, for example, one second or more has elapsed. In this case, when the shift position is changed to the next shift position in less than one second (NO), it is determined that the shift position is being changed, and the seat 3 is not vibrated.

In the S110 described above, when one second or more has elapsed after the change of the shift position is detected (YES), the process shifts to S120. In this S120, the vehicle speed is measured, and a vehicle stop state is determined, that is, it is determined whether the vehicle speed is equal to 0. Here, when the vehicle speed is equal to 0 (YES), it is determined that the vehicle is about to start, and the process shifts to S30 and S40. The seat 3 is vibrated. The processes in S30 and S40 are executed similarly to the first embodiment.

In the S120 described above, when the vehicle speed is not equal to 0, that is, the state is the travel state (NO), the process shifts to S130. In this S130, a current position of the vehicle, that is, the own vehicle position is detected by, for example, the GPS receiver. It is determined whether the own vehicle position is not on the road, that is, the vehicle is traveling on a place other than the road. Here, when the vehicle is traveling on the place, for example, a parking lot other than the road (YES), it is necessary to avoid collision with an obstacle or the like. Therefore, the process shifts to S30 and S40, and the seat 3 is vibrated. In the S130 described above, when the vehicle is traveling on the road, the process shifts to “NO”, the seat 3 is not vibrated.

Configurations according to the second embodiment other than those described above are similar to corresponding configurations according to the first embodiment. The second embodiment thus achieves substantially the same functional effect as that according to the first embodiment. Particularly, according to the second embodiment, even in the case where the shift position is changed, when the shift position is changed to the next shift position in less than one second after the change of the shift position is detected, or even in the case where one second or more has elapsed after the change of the shift position is detected, when the vehicle is traveling on the road, the seat 3 is not vibrated. Therefore, it may be possible to prevent the driver from feeling annoyed.

In each of the embodiments described above, as the vibration applying device 4, the vibration mechanism including the electromagnet 20, the plate spring 22, or the like is employed. However, it is not limited to this. For example, a vibration mechanism including a motor or the like, a vibration mechanism using sound, or the like may be employed.

In each of the embodiments described above, in the configuration of applying the tactile stimulation to the driver, the vibration applying device 4 vibrates the seat 3. However, it is not limited to this. For example, the steering wheel may be vibrated. The wind may be blown to the driver. In a case of the configuration of vibrating the steering wheel, it is preferable that the multiple types of vibration patterns of the steering wheel are provided with respect to the shift positions. In the configuration of blowing the wind to the driver, it is preferable that multiple types of patterns for blowing the wind are provided with respect to the shift positions. In this case, it is preferable that cold air or warm air is employed. Further, it is preferable that not only a direction from the front but also a direction from the rear, the upper, the side, or the like may be appropriately provided as a direction in which the window is blown.

Although the present disclosure has been described in accordance with the embodiments, it is understood that the present disclosure is not limited to such embodiments and configurations. The present disclosure covers various modifications and equivalent arrangements. In addition, various combinations and forms, and further, other combinations and forms including only one element, or more or less than these elements are also within the scope and the spirit of the present disclosure.

The controllers and methods described in the present disclosure may be implemented by a special purpose computer created by configuring a memory and a processor programmed to execute one or more particular functions embodied in computer programs. Alternatively, the controllers and methods described in the present disclosure may be implemented by a special purpose computer created by configuring a processor provided by one or more special purpose hardware logic circuits. Alternatively, the controllers and methods described in the present disclosure may be implemented by one or more special purpose computers created by configuring a combination of a memory and a processor programmed to execute one or more particular functions and a processor provided by one or more hardware logic circuits. The computer programs may be stored, as instructions being executed by a computer, in a tangible non-transitory computer-readable medium.

Here, the process of the flowchart or the flowchart described in this application includes a plurality of sections (or steps), and each section is expressed as, for example, S1. Further, each section may be divided into several subsections, while several sections may be combined into one section. Furthermore, each section thus configured may be referred to as a device, module, or means.

1. A driving assistance apparatus comprising:
a detector configured to detect a shift position of a transmission of a vehicle;
a stimulator configured to stimulate a driver;
a stimulation controller configured to control actuation of the stimulator to stimulate the driver in a stimulation pattern in accordance with the shift position; and
a determiner configured to determine whether to be necessary to stimulate the driver even when the shift position is changed,
wherein:
even in a case where the shift position is changed, the stimulation controller controls the stimulator not to stimulate the driver when the determiner determines to be unnecessary to stimulate the driver;
the determiner determines to be unnecessary to stimulate the driver when a setting time does not elapse after the detector detects that the shift position is changed; and
even in a case where the setting time elapses after the determiner detects that the shift position is changed, the determiner determines to be unnecessary to stimulate the driver when the vehicle travels on a road.

2. The driving assistance apparatus according to claim 1, wherein:
the stimulator includes a vibration applying device configured to vibrate a seat of a driver seat.

3. The driving assistance apparatus according to claim 2, wherein:
the vibration applying device includes a vibration actuator placed at each of four corners of a seat surface of the seat.

4. The driving assistance apparatus according to claim 3, wherein:
when the shift position is changed, the stimulation controller provides vibration in the vibration pattern in accordance with a changed shift position to the driver.

5. A driving assistance apparatus comprising:
an actuator configured to stimulate a driver;
one or more processors; and
a memory coupled to the one or more processors and storing program instructions that when executed by the one or more processors cause the one or more processors to at least:
detect a shift position of a transmission of a vehicle;
control actuation of the actuator to stimulate the driver in a stimulation pattern in accordance with the shift position; and
determine whether to be necessary to stimulate the driver even when the shift position is changed,
wherein:
even in a case where the shift position is changed, the processor controls the actuator not to stimulate the driver when the processor determines to be unnecessary to stimulate the driver;
the processor determines to be unnecessary to stimulate the driver when a setting time does not elapse after the processor detects that the shift position is changed; and
even in a case where the setting time elapses after the processor detects that the shift position is changed, the processor determines to be unnecessary to stimulate the driver when the vehicle travels on a road.
